(19) United States
(12) Patent Application Publication
(10) Pub. No.: US 2009/0301309 A1
(43) Pub. Date: Dec. 10, 2009

(54) Production And Processing Unit For A Synthesis Gas Comprising A Steam Reformer

(76) Inventor: Patrick Pereira, Chilly-Mazarin (FR)

Correspondence Address: AIR LIQUIDE;Intellectual Property, 2700 POST OAK BOULEVARD, SUITE 1800, HOUSTON, TX, 77056, US

(21) Appl. No.: 12/374,373

(22) PCT Filed: Aug. 6, 2007
(86) PCT No.: PCT/FR07/51788

§ 371 Date: Jul. 23, 2009

(30) Foreign Application Priority Data
Aug. 8, 2006 (FR) 0653311

(51) Int. Cl. B01D 53/18; B01D 47/12

(52) U.S. Cl. 96/201; 96/370

(57) ABSTRACT

A production and processing unit for a synthesis gas obtained by reforming from a mixture of light hydrocarbons, of the type comprising at least one steam methane reformer (SMR) for the production of a synthesis gas, as well as independent functional elements (or units) for processing the mixture of hydrocarbons upstream to the reforming unit and for processing the synthesis gas downstream from the reforming unit is provided.

The present invention relates to a production and processing unit for a synthesis gas obtained by reforming from a mixture of light hydrocarbons, of the type comprising at least one steam methane reformer (SMR) for the production of a synthesis gas, as well as independent functional elements (or units) for processing the mixture of hydrocarbons upstream to the reforming unit and for processing the synthesis gas downstream from the reforming unit.

The invention applies in particular to a final provision of hydrogen. In this case, the unit will conventionally comprise, apart from the steam reformer, all or part of the following independent elements: a hydro-desulfurization system or HDS, one or more functional elements for cooling the synthesis gas, a CO conversion module (shift), possibly a module for removing CO₂, a module for separating hydrogen, generally by pressure swing adsorption or PSA but also compressors as well as other various technical elements whose function is to receive supplies from outside (from the provider or customer) and provided at battery limits.

These various functional elements are connected together and/or to the reformer by a certain number of connecting conduits with their safety devices as well as their automatic valves and/or remote controls.

The steam reformer comprises, in its main lines:
a radiation chamber, which is equipped with tubes through which the mixture of hydrocarbons and steam pass, which is the location of reforming reactions, the heat necessary for the reactions being provided by heating the tubes with burners, supplied with fuel and air,
a convection chamber, which is the location of the convection line, heat being recovered there, via exchangers, from fumes generated in the radiation chamber, this heat serving notably to generate steam.

The steam reforming step is frequently preceded by a pre-reforming step. Conventionally, the pre-reformer is directly connected to the reformer and does not constitute a distinct functional element. This is why it will not be taken into consideration in the remainder of the description. When reading the word “reformer”, this will be understood to mean a reformer or pre-reformer plus reformer unit.

Thus, for any unit for the production of hydrogen (or CO or H₂/CO) obtained from a reforming gas coming from a steam reformer, the assembly of functional elements concerned constituting the production units is distributed about a rack. This rack is in the form of a metal structure about which various elements (functional elements and reformer) are disposed. The available space under the rack is used for the passage of various fluids entering and leaving (electricity, gas, water, products, etc.) via various ducts and conduits, but also for the installation of various items of small-sized equipment.

In a conventional architectural scheme, the arrangement of the various elements disposed about the rack is achieved in the following manner:
the reformer, that is either of the top-fired or side-fired type, is an element with a rectangular shape at its base and is placed on one long side of the rack parallel thereto,
the reformer is generally fed with fuel at the rear, that is to say at the end of the reforming furnace opposite the convection line,
other functional elements (pressure swing adsorption or PSA, hydro-desulfurization or HDS, cooling of the synthesis gas, etc.) are situated on the other long side of the rack perpendicular thereto,
utilizable fluids (supply fluids, process fluids, products as well as utilities: cooling water, instrumentation air, nitrogen, steam, flare gas, etc.) passing through ducting along the rack. They are essentially supplied and/or removed at one end thereof, in the region of the battery limit, where the connection with the outside is made,
connecting conduits (ducting, electrical supply) between various functional assemblies are disposed along the rack.

The subject of the present invention is a unit for the production of a gas or gaseous mixture obtained by processing a mixture of light hydrocarbons by reforming, of the type comprising at least one steam methane reformer (SMR) for the production of synthesis gas, as well as functional elements for processing the mixture of hydrocarbons upstream to the reforming unit and for processing the synthesis gas downstream from the reforming unit. The unit according to the invention will have a lower construction cost by virtue of optimized use of racks by more complete exploitation both of the perimeter of the rack as well as its surface area, optimized use that will in this way enable the size to be reduced. The invention also makes it possible to reduce the lengths of manifolds as well as the ducting and cables for electrical supply, the volumes of civil engineering situated under the rack and the structure of the rack.

To this end, the invention relates to a unit for the production and processing of synthesis gas from a mixture of hydrocarbons, comprising at least:
a steam reformer
functional elements for processing a mixture of hydrocarbons upstream to the reformer and/or for processing synthesis gas downstream from the reformer,
a rack with an overall rectangular form, having two long sides of dimension L and two short sides, also called ends, for the distribution of said reformer and said functional elements, as well as that of the conduits enabling gaseous, liquid and electrical fluids to be transferred,
   characterized in that the reformer is placed substantially perpendicular to the rack and at one end, and/or the functional elements are distributed over the two sides of the rack of dimension L.

Since the reformer is placed at one of the two ends of the rack, and along an axis substantially perpendicular thereto, the installation will be said to be arranged in a “T” architecture. The fluids (gaseous, liquid and electrical) are advantageously fed in and/or removed at the second end.

The rack as described above is a rack with a rectangular shape, having two large sides of dimensions L, called long sides, and two small sides or ends. It is obvious that its shape may have minor variants and notably that additional rack elements may be added to the rack, as long as their areas are very much less than those of the main rack.

Preferably, since at least the functional elements are interconnected (directly connected) via conduits, they are distributed so as to minimize the length of said conduits.

Advantageously, at least two interconnected functional elements are placed substantially face-to-face, either side of the rack.

One of the functional elements for processing the mixture of hydrocarbons upstream from the reformer may be a hydro-desulfurization module.

When at least one feed fluid intended for the production of synthesis gas is naphtha, one of the functional elements for processing upstream to the reformer is a module for the pre-processing of naphtha (or naphtha module).

The invention is particularly suitable for the production of hydrogen, and thus a preferred embodiment of the invention relates to a unit that comprises functional elements for the processing of synthesis gas with a view to producing hydrogen.

In this gas, the installation for the production of hydrogen advantageously comprises all or part of the following functional elements:
a hydro-desulfurization assembly (HDS) for processing the mixture of hydrocarbons upstream to the reformer,
a module for cooling the synthesis gas,
a module for purifying hydrogen (PSA),
a compressor for recycled hydrogen for feeding the HDS, also called “a recycled H₂ compressor”
a nitrogen start-up module of the HDS and of the reformer (nitrogen SU).

According to another variant of the invention, this relates to a unit characterized in that it comprises functional elements for processing synthesis gas with a view to producing an H₂/CO mixture.

In this case, the installation may comprise notably all or part of the following functional elements:
an HDS assembly,
a module for cooling the synthesis gas,
a recycled H₂ compressor
a nitrogen start-up module.

According to another variant of the invention, this relates to a unit comprising functional elements for processing synthesis gas with a view (also) to producing carbon monoxide. In this case, it may include notably, in addition to the above elements:
a unit for removing CO₂, of the MDEA type for instance,
a CO cold box.

The reformer is of the type comprising a radiation chamber and a convection chamber and it typically consists of a steam reformer. The reformer will advantageously be of the steam reformer type for the production of synthesis gas from a mixture of light hydrocarbons to be reformed, comprising at least one reforming furnace containing reforming tubes for reforming methane contained in said mixture as well as burners for providing the heat necessary for reforming, means for supplying said mixture to be reformed and steam, means for feeding the furnace with fuel designed to provide fuel for the burners, a convection line for recovering fumes leaving the furnace, in which the means for supplying the furnace with fuel are situated at the end of the furnace, on the convection chamber side, in this way making it possible to limit the length of conduits.

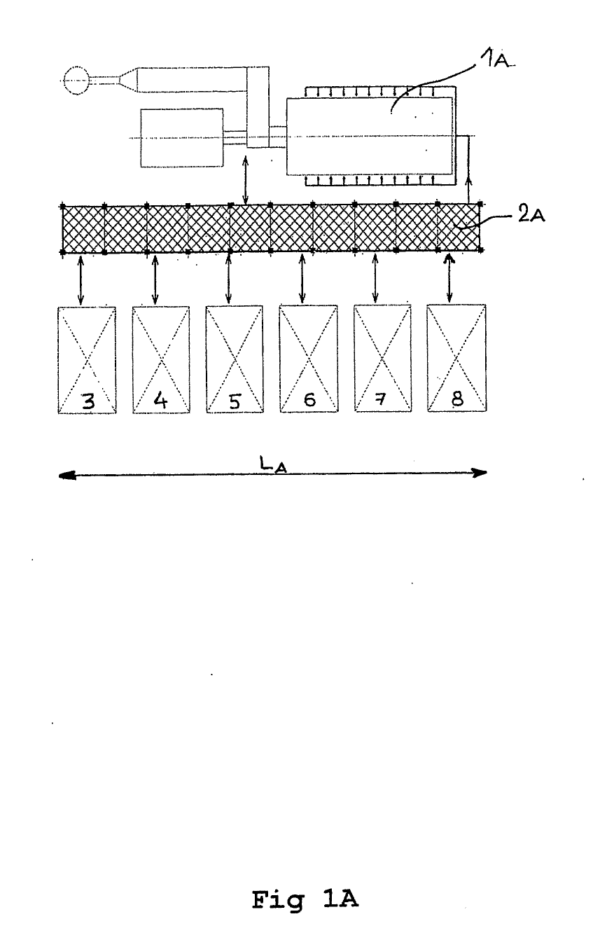

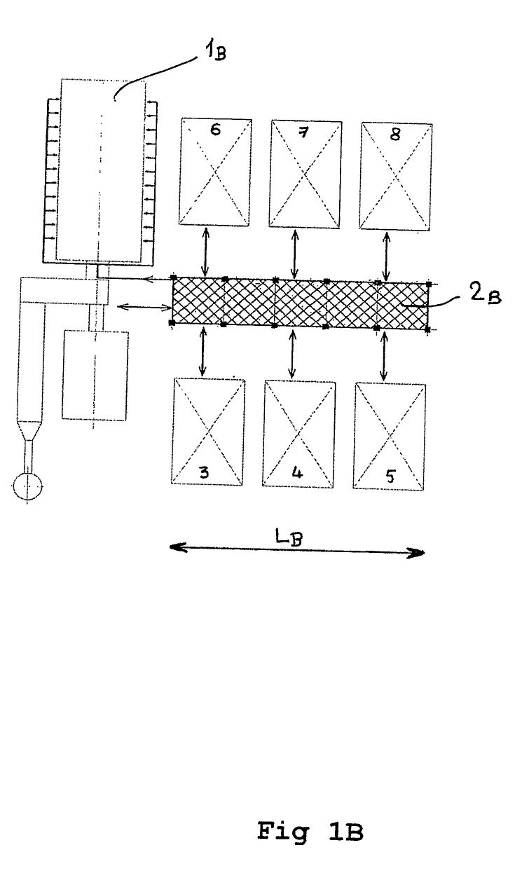

The invention will be better understood on reading the following description, given only by way of example, made with reference to the appended drawings in which FIGS. 1A, 2A, 3A and 4A illustrate conventional architectures according to the prior art, while FIGS. 1B, 2B, 3B and 4B illustrate architectures according to the invention.

FIG. 1A shows schematically an installation for the production and processing of synthesis gas according to a known conventional arrangement.

FIG. 1B shows schematically a comparable installation for the production and processing of synthesis gas arranged according to the “T” architecture of the invention.

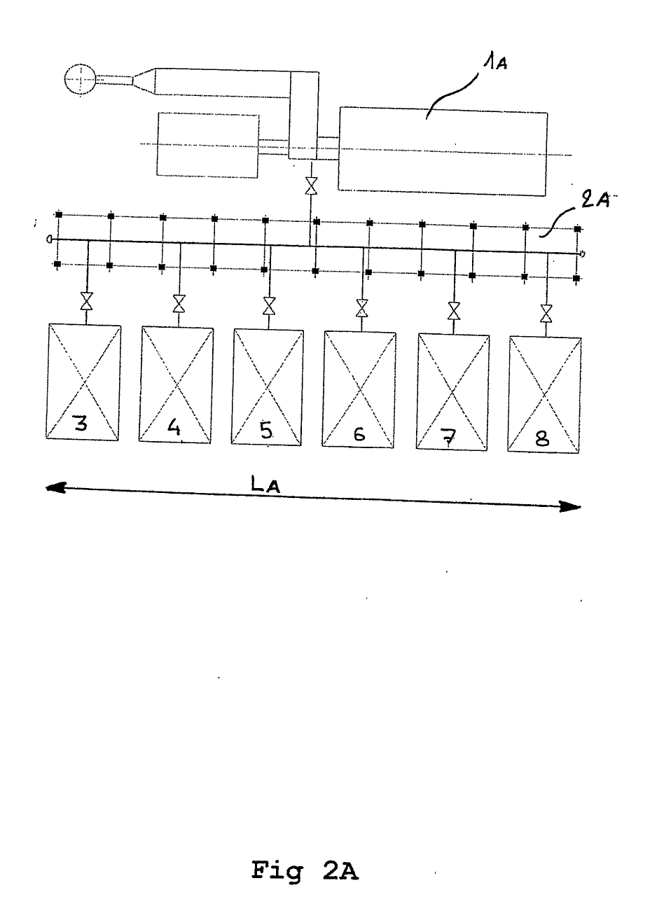

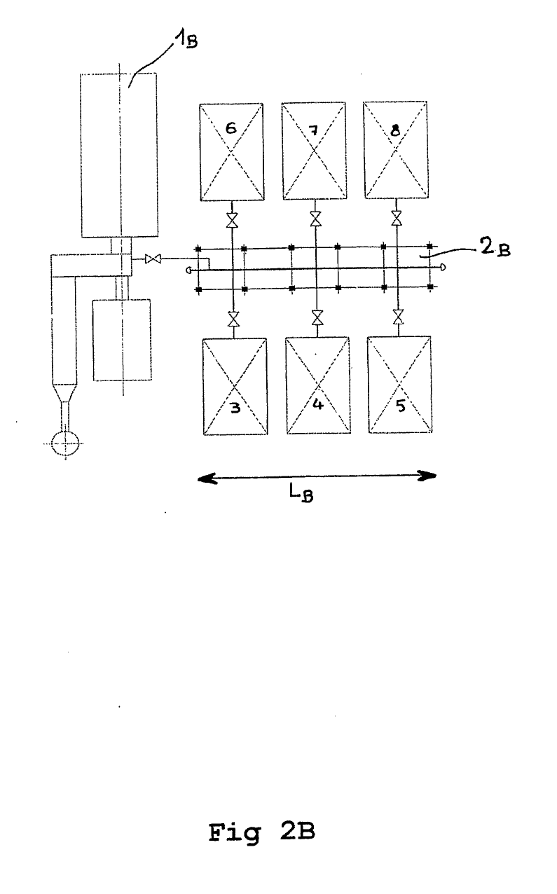

FIG. 2A shows schematically manifolds for utilities of the installation of FIG. 1A.

FIG. 2B shows schematically manifolds for utilities of the installation of FIG. 1B according to the invention.

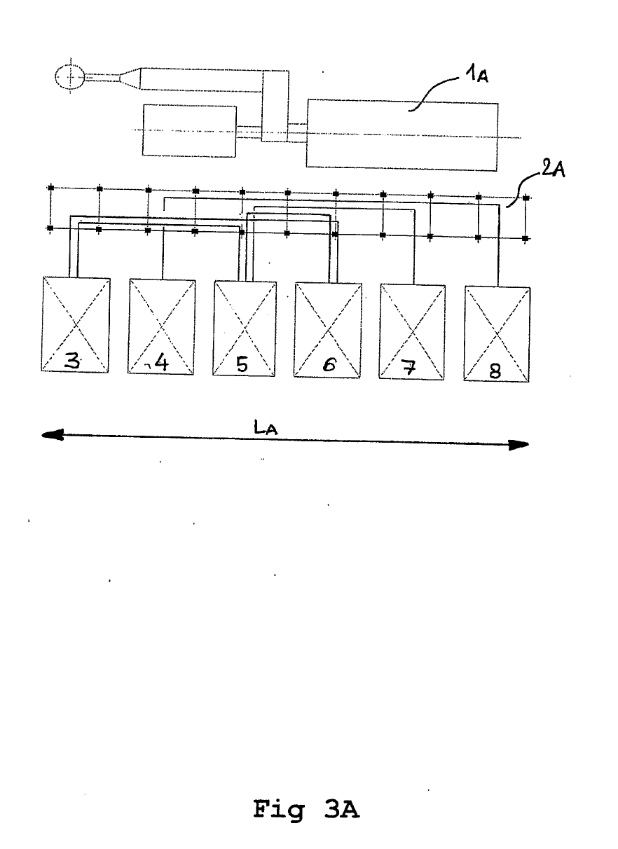

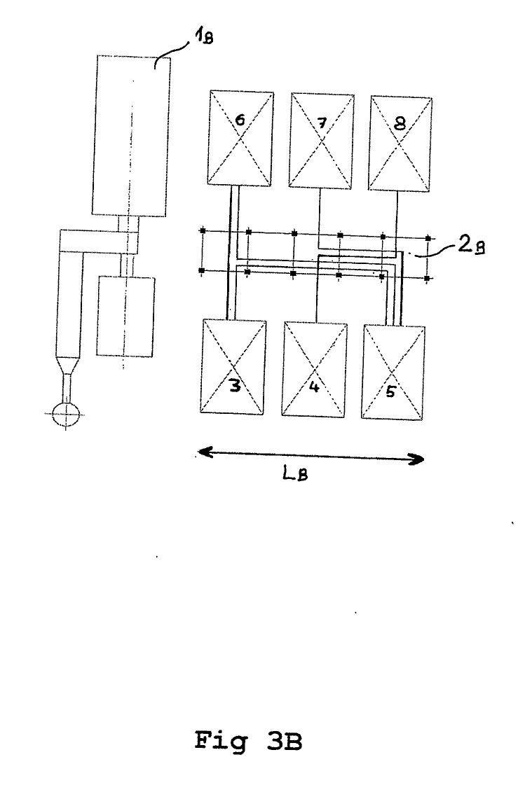

FIG. 3A shows schematically interconnections between the functional assemblies of the installation of FIG. 1A.

FIG. 3B shows schematically interconnections between functional assemblies of the installation of FIG. 1B according to the invention.

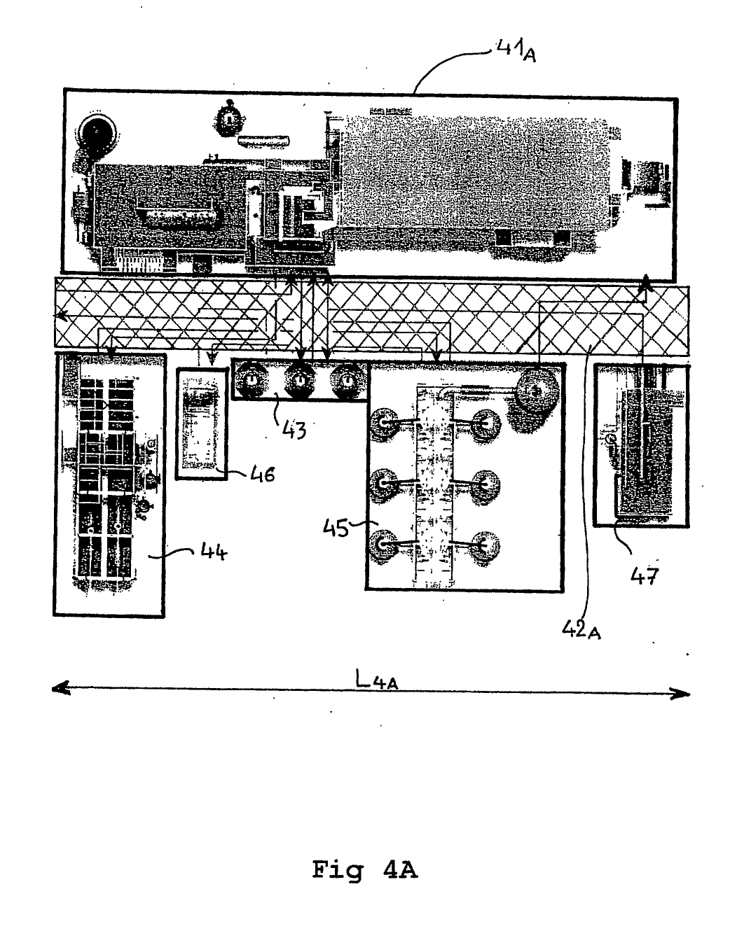

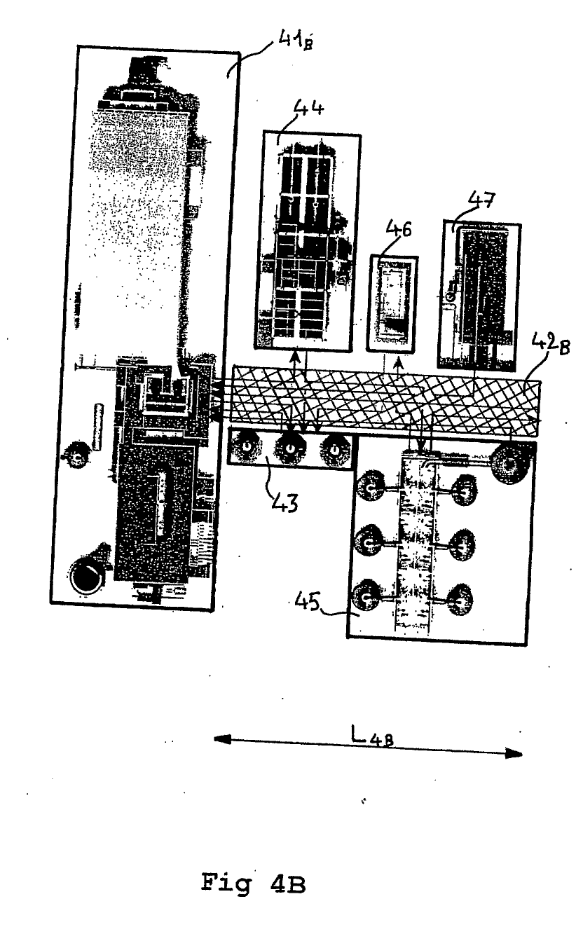

FIG. 4A illustrates the special case of a conventional installation for the production of hydrogen.

FIG. 4B illustrates the special case of an installation equivalent to that of FIG. 4A, but arranged according to the “T” architecture of the invention.

It should be understood that the invention is not limited to the embodiments described, in particular in FIGS. 1B to 4B. In point of fact, installations according to the invention will not contain all the functional assemblies described, while installations according to the invention may in addition contain other functional assemblies.

The installation shown in FIG. 1A comprises:
a reformer 1_{A} of the type fed with fuel at the rear in a conventional manner,
a rack 2_{A} of length L_{A},
six distinct sub-assemblies or functional assemblies, reference 3 to 8.

The reformer 1_{A} is arranged parallel to the rack 2_{A}, along one of the sides of length L_{A}. The six functional assemblies 3 to 8 are arranged on the other side of the rack 2_{A}, perpendicular thereto.

The installation according to the invention, shown in FIG. 1B, is comparable and consists of the same number of elements of the same nature, that is to say: a reformer and rack as well as the same six distinct sub-assemblies or functional assemblies, in which:
the reformer 1_{B} is a preferred reformer according to the invention and is fed with fuel at the end of the furnace on the convection chamber side, that is substantially in its central part, (it could be fed at its end, using suitable feed means),
the rack 1_{B} is of length L, that is substantially of length L_{A/}2,
the six sub-assemblies 3 to 8 are the same as those of FIG. 1A.

The reformer 1_{B} according to the invention is placed perpendicular to the rack, at one of its ends, in this way completely freeing one length of the rack L. The six functional assemblies 3 to 8 may thus be distributed over the two available sides of the rack 2^{B} of length L where they have available the total length of the rack 2×L, that is equivalent to that which they have available in the arrangement according to FIG. 1A.

In FIGS. 2A and 2B, conduits are shown schematically that are intended to feed the reformer with utilizable fluids, as well as the various functional assemblies 3 to 8 of the installations of FIGS. 1A and 1B. The utilizable fluids (cooling water, instrumentation air, nitrogen, steam, flare gas, etc.) pass in this way via ducts grouped together in the region of the rack. For each fluid, the ducting coming from the various elements among 1_{B} and 3 to 8, rejoin a manifold called a utility manifold, positioned along the rack, which thus has a length that is substantially equal to that of the rack itself. These manifolds ensure the distribution of all utilizable fluids along the rack between the conduits dedicated to the functional assemblies or to the reformer and means for supplying or removing said utilizable fluids, means situated at the end of the rack where the connection with the customer is conventionally made. These also ensure the distribution of fluids that may be generated by one of the assemblies.

Thus, here where the installation of FIG. 2A requires manifolds of length 2×L, that of FIG. 2B only requiring manifolds of length L. In the same way, the conduits have their lengths divided by 2 (reduced by L), which results in a considerable saving.

In addition, and according to their functions, a certain number of functional assemblies have to be interconnected. Some interconnections have been shown schematically in FIGS. 3A and 3B between the various functional assemblies 3 to 8 making up the installations of FIGS. 1A and 1B.

Thus, the functional assembly 3 is interconnected with the functional assemblies 5 and 6, the functional assembly 4 is interconnected with the functional assembly 8 and the functional assembly 5 is moreover interconnected with the functional assemblies 6 and 7.

In FIG. 3A, where the functional assemblies are grouped along the rack on a single side, according to the known conventional architecture, these interconnections require the assembly of ducts to be disposed in parallel along the rack, which corresponds to large cumulated ducting lengths, much longer than the length of the rack.

In FIG. 3B where the reformer is placed at the end of the rack, and where the functional assemblies are distributed either side of the rack in the “T” architecture according to the invention, the cumulated length of the ducting on the rack is thus greatly reduced, and this even more so when the elements are interconnected to a high degree. In this case, a judicious distribution of functional elements either side of the rack, in particular positioning some interconnected functional elements face-to-face, makes it possible to create direct links between these functional elements and therefore to free space on the rack.

The installation for producing hydrogen of FIG. 4A is a conventional installation that comprises:
a reformer 41_{A} of the type fed with fuel at the rear in a known manner;
a rack 42_{A} of length L_{4A};
the following 5functional assemblies, referenced 43 to 47:
   • 43: a hydro-desulfurization assembly (HDS) for processing the mixture of hydrocarbons upstream to the reformer,
   • 44: a module for cooling the synthesis gas,
   • 45: a module for purifying hydrogen (PSA),
   • 46: a recycled hydrogen compressor for feeding the HDS, also called “a recycled H₂ compressor”,
   • 47: a nitrogen start-up module for the HDS and for the reformer (Nitrogen SU).

This installation is designed to produce hydrogen from a source of hydrocarbons composed of natural gas and operates in the following manner: natural gas NG supplies the hydro-desulfurization assembly 43, and then the desulfurized gas leaving this is introduced into the reformer 41_{A} where it is reformed to provide a hot synthesis gas. The hot synthesis gas passes into the cooling module 44 and is then introduced into the PSA purification module 45 in order to produce hydrogen. The H₂ produced is mainly conveyed to the end of the rack towards the customer, a fraction of the H₂ being conveyed to the HDS assembly 43 after compression in the compressor 46. In addition, the nitrogen start-up module 47 supplies the reformer 41_{A} as well as the HDS 43 with nitrogen intended for the start-up phases. A significant fraction of natural gas is used as fuel for the reformer, complementing the residual gas of the PSA.

The reformer 41_{A} is disposed parallel to the rack 42_{A} along one of the sides of length L_{4A}.

The functional assemblies 43 to 47 are disposed on the other side of the rack, perpendicular thereto.

All the fluids pass along the rack. They consist of process fluids, namely natural gas, synthesis gas and the hydrogen produced, but also nitrogen and recycled hydrogen as well as all the utilities.

The installation according to the invention, shown in FIG. 4B is comparable and consists of the same number of elements of the same nature, namely:
a reformer 41_{B}, but it is here of the preferred reformer type according to the invention, that is to say it is fed with fuel at the end of the furnace on the convection chamber side, that is to say substantially in its central part;
a rack 42_{B} of length L_{4B};
the following 5 functional assemblies, referenced 43 to 47 (they are identical to those of FIG. 4A):
   • 43: a hydro-desulfurization assembly (HDS) for processing the mixture of hydrocarbons upstream to the reformer,
   • 44: a module for cooling the synthesis gas,
• 45: a module for purifying hydrogen (PSA),
   • 46: a recycled hydrogen compressor for supplying the HDS, also called “a recycled H₂ compressor”,
   • 47: a nitrogen start-up module for the HDS and for the reformer (SU nitrogen).

The installation of FIG. 4B operates in the same manner as that of FIG. 4A, that is to say in the following manner: this installation is designed to produce hydrogen from a source of natural gas; natural gas NG supplies the hydro-desulfurization assembly 43, and then the desulfurized gas leaving this is introduced into the reformer 41_{B} where it is reformed to provide a hot synthesis gas. The hot synthesis gas passes into the cooling module 44 and is then introduced into the PSA purification module 45 in order to produce hydrogen. The H₂ produced is mainly conveyed to the end of the rack towards the customer, a fraction of the H₂ being conveyed to the HDS assembly 43 after compression in the compressor 46. In addition, the nitrogen start-up module 47 supplies the reformer 41_{B} as well as the HDS 43 with nitrogen intended for the start-up phases. A significant fraction of natural gas is used as a fuel for the reformer, complementing the residual gas of the PSA.

All the fluids pass along the rack. They consist of process fluids, namely natural gas, synthesis gas and the hydrogen produced, but also nitrogen and recycled hydrogen as well as all the utilities.
the reformer 41_{B} is a preferred reformer according to the invention: it is fed with fuel at the end of the furnace on the convection chamber side, that is to say substantially in its central part;
the rack 42_{B} is of length L_{4B}, that is substantially L_{4A}/2;
the five elements 43 to 47 are the same as those of FIG. 4A.

The reformer 41_{B} according to the invention is placed perpendicular to the rack, at one of its ends, in this way freeing all one length of the rack L_{4A/}2. The five functional elements may thus be distributed over the two available sides of the rack where they have available in this way twice the length of the rack L_{4B}, equivalent to L_{4A} (that which they have available in the arrangement according to FIG. 4A).

The arrangement of the elements 43 to 47 is judiciously chosen so as best to exploit the available space around the rack but also to minimize the length of conduits. Thus, the element 46 (recycle compressor) is placed substantially facing the PSA 45 and substantially facing the HDS 43.

The length of the conduits conveying the various fluids is minimized on the one hand due to the placement of the elements in relation to each other, but also and especially since the rack is twice as short as in the known conventional solution.

Thus then, as the figures and examples illustrate, the arrangement of installations intended for steam reforming of a mixture of light hydrocarbons for the production of a synthesis gas as well as the subsequent processing of the synthesis gas according to the “T” architecture of the invention, make it possible to reduce significantly the construction costs of the installation by virtue of a reduction:
by a factor substantially equal to two of the length of the rack necessary for distributing the functional element making up the installation, but also
by a lesser but significant factor of the length of conduits as it concerns ducting for the passage of liquid and gaseous fluids and as it concerns electrical cables.

This arrangement will be even more advantageous if a reformer is used of which the means for feeding the furnace with fuel is situated at the end of the furnace, on the convection chamber side. This makes it possible to minimize the length of conduits between the end of the rack and said supply means.

Particularly suited for the production of hydrogen, the invention may also be employed for the production of carbon monoxide and/or of a mixture of the two, as long as a reformer is used equipped with a furnace and a convection chamber.

1-7. (canceled)

8. A unit for the production and processing of synthesis gas from a mixture of hydrocarbons, comprising:
a steam reformer;
functional elements for processing the mixture of hydrocarbons upstream of the reformer and/or for processing synthesis gas downstream of the reformer,
a rack with an overall rectangular form, having two long sides of dimension L and two short sides, for the distribution of the reformer and the functional elements, as well as that of the conduits enabling gaseous, liquid and electrical fluids to be transferred,
wherein the reformer is placed substantially perpendicular to the rack and at one end, and/or the functional elements are distributed over the two sides of the rack of dimension L.

9. The unit as claimed in claim 8, wherein at least the functional elements are interconnected via conduits, and wherein the functional elements are distributed so as to minimize the length of the conduits.

10. The unit as claimed in claim 9, wherein at least two interconnected functional assemblies are placed substantially face-to-face, on either side of the rack.

11. The unit as claimed in claim 8, wherein the functional elements are for the processing of synthesis gas with a view to producing hydrogen.

12. The unit for producing hydrogen as claimed in claim 11, wherein one or more of the functional elements are selected from the group consisting of:
a hydro-desulfurization assembly (HDS) for processing the mixture of hydrocarbons upstream to the reformer,
a module for cooling the synthesis gas,
a module for purifying hydrogen (PSA),
a compressor for recycled hydrogen for feeding the HDS, also called “a recycled H₂ compressor”, and
a nitrogen start-up module of the HDS and of the reformer (nitrogen SU).

13. The unit as of claim 8, wherein the functional elements are for processing synthesis gas with a view to producing an H₂/CO mixture.

14. The unit as claimed claim 8, wherein the functional elements are for processing synthesis gas with a view to producing carbon monoxide.
